(19) United States
(12) Patent Application Publication
(10) Pub. No.: US 2017/0158013 A1
(43) Pub. Date: Jun. 8, 2017

(54) Wheel suspension for a motor vehicle

(71) Applicant: AUDI AG, Ingolstadt (DE)

(72) Inventor: Dominik MOHRLOCK, Buxheim (DE)

(73) Assignee: AUDI AG, Ingolstadt (DE)

(21) Appl. No.: 15/367,786

(22) Filed: Dec. 2, 2016

(30) Foreign Application Priority Data
Dec. 3, 2015 (DE) 10 2015 015 613.6

(51) Int. Cl. B60G 11/00; B62D 21/11; B60G 3/18

(52) U.S. Cl. CPC B60G 11/00; B60G 3/18; B62D 21/11; B60G 2200/14; B60G 2204/418

(57) ABSTRACT

A wheel suspension for a motor vehicle with an auxiliary frame connected through auxiliary frame bearings with the vehicle body. A support spring is arranged between the vehicle body and a spring link at the auxiliary body, and exerts spring forces on the spring link and thus indirectly on the auxiliary frame. The support spring is arranged near the auxiliary bearings which act in the vehicle direction between the auxiliary frame and the vehicle body. Due to the proximity of the auxiliary bearings to the support spring, a part of the spring forces exerted by the support spring is directly guided through the support bearings into the vehicle body.

The invention relates to a wheel suspension for a motor vehicle.

A wheel suspension for a motor vehicle, which is known for example from DE 197 08 421 A1, has an auxiliary frame provided with four auxiliary frame bearings that connect the auxiliary frame to the body of the vehicle and at the same time decouple the vehicle body from the stimuli caused by the roadway. The support spring is arranged on a connecting link that is also arranged on the auxiliary frame. The auxiliary frame bearings absorb with this wheel suspension also forces in the direction of the vehicle, which are generated due to the spring forces by the supporting spring on the connecting link and thus are indirectly generated on the auxiliary frame and cause pre-tensioning of the auxiliary frame.

The goal of the design of auxiliary frame bearings is to achieve a low stiffness in the x direction of the vehicle (the direction of travel), a high stiffness in the y direction (the transverse direction of the vehicle) and a low stiffness in the z direction (the vertical direction of the vehicle). The pre-tensioning of the auxiliary frame restricts adaptability of the auxiliary frame bearings because only a certain relationship can be achieved between the stiffness in the different directions. Due to the high forces in the vertical direction of the vehicle, the auxiliary frame bearings must be designed for high pre-tensioning, which, however leads to disadvantages with respect to the strength of the auxiliary frame.

The object of the invention is to provide a wheel suspension for motor vehicles, which makes it possible to expand the possibilities for adapting the auxiliary frame so that there are fewer restrictions on the adjustment of the auxiliary frame.

For this purpose, the wheel suspension for motor vehicle according to the invention is provided with an auxiliary frame that is connected to the body of the vehicle through auxiliary frame bearings, which are arranged between the axle tie rod and the vehicle body and thus exerts spring forces on the auxiliary frame, characterized in that in the region near the support spring, additional bearings acting in the direction of the travel of the vehicle are arranged between the auxiliary frame and the vehicle body, wherein due to the proximity of the additional bearings to the support spring, one part of the spring force exerted by support spring is guided directly via the additional bearings into the car body.

The pre-tensioning caused by the support spring is absorbed by the additional bearings so that the auxiliary frame bearings are at least partially relieved of the pre-tensioning by the support spring. The auxiliary bearings are less pre-tensioned by the support spring and they can thus be provided with better design/dimensions. The possibilities for the design of the strength achieved are also improved. Because the additional bearings transmit substantially only forces in the vertical direction of the vehicle and not in the direction of the vehicle's length, the result is that this makes it possible to prevent in an advantageous manner longitudinal pliability of the axle.

According to an advantageous embodiment, the wheel suspension according to the invention is characterized in that the additional bearings are adapted to the vertical forces. Therefore, the stiffness of the additional bearings and of the auxiliary frame can be matched to the respective requirements, or according to the design goals depending on the stiffness of the auxiliary bearings.

According to another preferred embodiment of the invention, the wheel suspension according to the invention is characterized in that the additional bearings are positioned in the region of the support spring, wherein the pre-tensioning forces are reduced both in a rear and in a front auxiliary frame. With a targeted positioning of the additional bearings, the front or the rear auxiliary frame bearings can be relieved if this is a desired characteristic or for reasons of strength.

According to another preferred embodiment, the wheel suspension according to the invention is characterized in that the additional bearings comprise an elastic pull coupler, which is arranged between the auxiliary frame and the car body. Similar pull couplers are a simple and effective means enabling to reduce the pre-tensioning load on the auxiliary bearings.

According to another preferred embodiment, the wheel suspension is characterized in that the pull coupler comprises at the end fastening bushings and an elastic connecting rod, or the pull coupler comprises at the end pliant fastening bushings and a rigid connecting rod. In both cases, this it advantageously ensures that the required reduction of the pre-tensioning load of the auxiliary frame bushings will be achieved with the pull coupler.

According to another preferred embodiment, the wheel suspension according to the invention is characterized in that the additional bearings comprise rubber bearings. Such rubber bearings can be easily integrated in the system of the wheel suspension and they provide a long-term means that makes it possible to achieve a reduction in the amount of the pre-tensioning load.

According to another preferred embodiment of the invention, the wheel suspension according to the invention is characterized in that the rubber bearings comprise a rubber element connected with the auxiliary frame and a housing connected with the vehicle body and surrounding the side facing away from the car body, wherein the rubber element is compressed by the auxiliary frames and by the car body with a releasable resilient connection. As a result, no traction is exerted on the rubber element, which is to be avoided.

Further advantages, features and possible applications of the present invention will become apparent from the following descriptions based on the illustrations of embodiments shown in the figures.

The figures show the following:

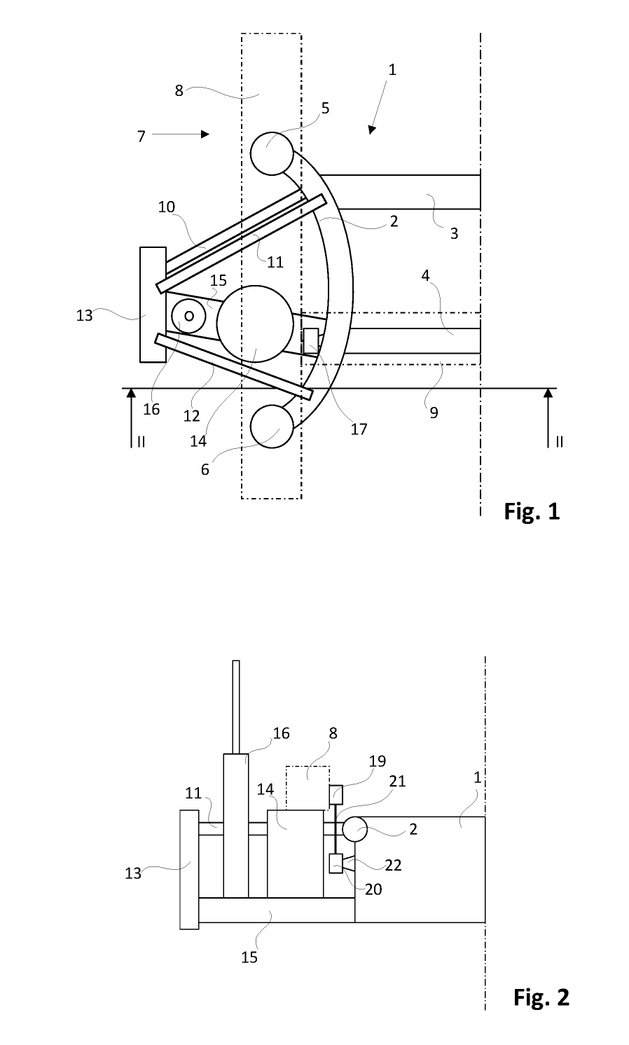

FIG. 1 a top view of the wheel suspension according to the invention;

FIG. 2 a rear view of the wheel suspension along the line II-II of FIG. 1;

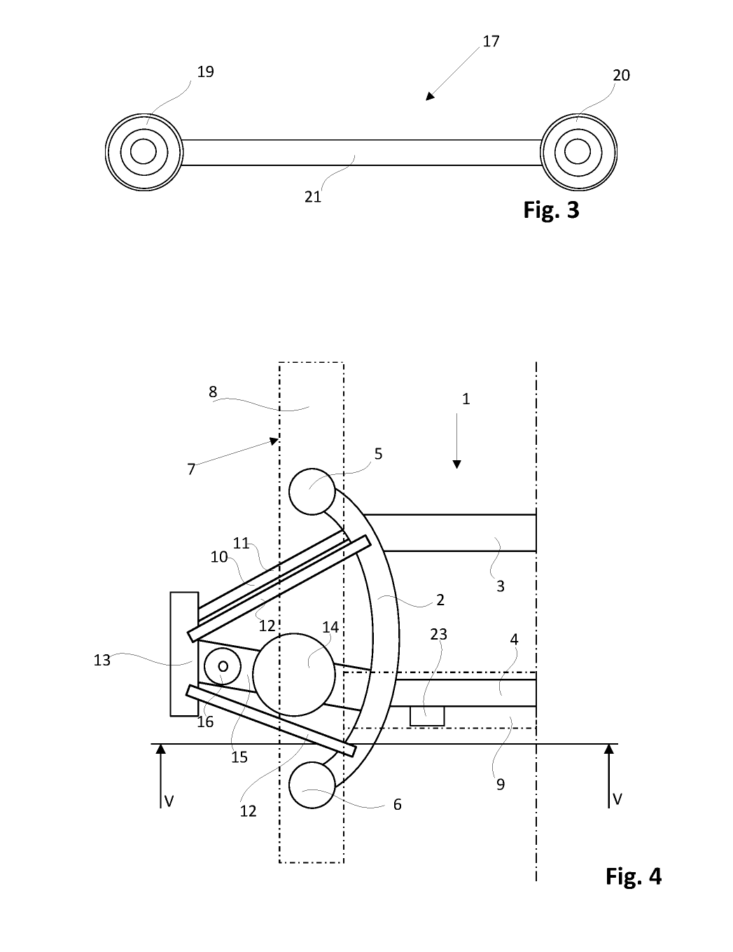

FIG. 3 a top view of the pull coupler used in the embodiment of FIGS. 1 and 2;

FIG. 4 a top view of a second embodiment of the wheel suspension according to the invention,

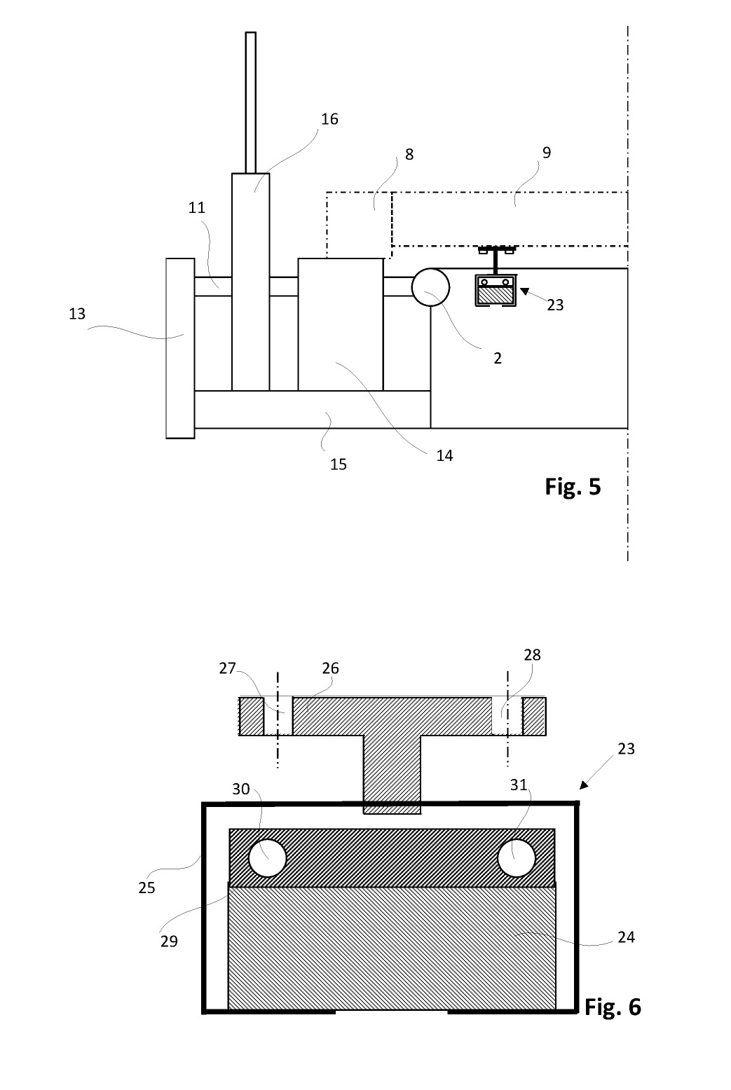

FIG. 5 a rear view of the wheel suspension according to the line V-V of FIG. 4, and

FIG. 6 is a top view of the embodiment of FIG. 4 and of the employed rubber bearing.

FIGS. 1 and 2 show a schematic and highly simplified top view, or a schematic and highly simplified rear view, of a first embodiment of the wheel suspension according to the invention, wherein the wheel suspension comprises an auxiliary frame 1 provided with longitudinal beams 2 and longitudinal beams 3, 4, which are connected to the vehicle body 7 of which two auxiliary frame bearings 5, 6 are shown that are connected with the vehicle body 7.

The vehicle body 7 is indicated schematically by longitudinal beam 7 and longitudinal beam 8. The longitudinal beam 2 of the auxiliary frame 1 is connected via a number of guide rods 10, 11 and 12 in a per se known manner with a wheel carrier 13. A support spring 14 of the wheel suspension is supported on one side on a spring link 15 at the auxiliary frame, and on the other side on the vehicle body 7. The wheel suspension is completed by a damper 16, which is also arranged on the spring link 15 and supported on the vehicle body 7.

The embodiment of the wheel suspension in accordance with the invention according FIG. 1 comprises in the vicinity of the support spring 14 additional bearings that act in the direction of the vehicle, of which is shown an additional bearing 17, arranged between the auxiliary frame 1 and the vehicle body 7, wherein due to the proximity of the additional bearing 17 to the support spring 14, one part of the spring forces exerted directly by the support spring 14 is guided via the additional bearing 17 into the vehicle body 7. The additional bearings 17 are adapted depending on the rigidity of the additional bearings 17 and of the auxiliary frame bearings 4, 5 to the forces to be absorbed.

The additional bearings 17 are positioned in the direction of travel in the region of the support spring 14, wherein the pre-tensioning forces are reduced both in a rear auxiliary frame bearing 5 and also in a front auxiliary frame bearing 6. In accordance with the embodiment according to FIGS. 1 and 2, the additional bearings comprise elastic pull couplers 17, which are arranged between the auxiliary frame 1 and the vehicle body 1. As shown in FIG. 3, the pull coupler 17 has end-facing, compliant fastening bushings 19, 20 and a rigid connecting rod 21. As shown in FIG. 2, the pull coupler 17 includes a mount 22, with which it is attached to the auxiliary frame 1. As an alternative that is not shown in the figures, the pull coupler comprises rigid fastening bushings and an elastic connecting rod between the fastening bushings.

In FIGS. 4 and 5 is shown in a schematic and highly simplified manner a rear view of a second embodiment of the wheel suspension according to the invention, wherein FIG. 5 shows a rear view of a wheel suspension along the line V-V of FIG. 4. The same reference numbers are used in FIGS. 4 and 5 for parts that are identical to those of the first embodiment.

The embodiment according to FIGS. 4 and 5 differs from the first embodiment only by an additional bearing, which comprises a rubber bearing arranged between the auxiliary frame 1 and the vehicle body 7, of which only a rubber bearing 23 is shown.

As shown in FIG. 6, the rubber bearing 23 comprises a rubber element 24 connected with the auxiliary frame 1, and a rubber element 24 connected with the vehicle body 7, and a housing 25 surrounding the rubber element 24 on the side facing away from the vehicle body 7, wherein the rubber element is compressed with a releasable resilient connection.

The housing 25 is connected via a flange 26 with the vehicle body, so that fastening bolts 27, 28 are used in the flange. The rubber element 24 is mounted on a base 29, which can be attached by using bores 30, 31 with bolts to the auxiliary frame 1.

Only one side of the wheel suspension is shown in the preceding description, while the other side is designed mirror-inverted.

1. A wheel suspension for a motor vehicle comprising:
an auxiliary frame connected to a vehicle body; and
a support spring arranged between the vehicle body and a spring link at the auxiliary frame, the support spring exerts spring forces on the spring link and thus indirectly on the auxiliary frame,
wherein auxiliary bearings are arranged proximate to the support spring between the auxiliary frame and the vehicle body and act in a direction of the vehicle, wherein due to the proximity of the auxiliary bearings to the support spring, a part of the spring forces exerted by the support spring is guided directly through the auxiliary bearings into the vehicle body.

2. The wheel suspension according to claim 1, wherein either front auxiliary bearings or rear auxiliary bearings are relieved with a targeted positioning or shifting of the auxiliary bearings in the longitudinal direction of the vehicle.

3. The wheel suspension according to claim 1, wherein the auxiliary bearings are adapted to the forces to be absorbed depending on the stiffness of the auxiliary bearings and the auxiliary frame bearings.

4. The wheel suspension according to claim 1, wherein the auxiliary bearings are positioned in the direction of travel in a region of the support spring, wherein pre-tensioning forces are reduced both by a rear auxiliary frame bearing and by a front auxiliary bearing.

5. The wheel suspension according to claim 1, wherein the auxiliary bearings further comprise:
elastic pull couplings arranged between the auxiliary frame and the vehicle body.

6. The wheel suspension according to claim 4, wherein the pull couplings further comprise:
rigid fastening bushings and an elastic connecting rod.

7. The wheel suspension according to claim 4, wherein the pull couplings further comprise:
pliant fastening bushings and a rigid connecting rod.

8. The wheel suspension according to claim 1, wherein the auxiliary bearings further comprise:
at least one rubber bearing arranged between the auxiliary frame and vehicle body.

9. The wheel suspension according to claim 7, wherein the rubber bearings further comprise:
a rubber element connected with the auxiliary frame and a surrounding housing connected with the vehicle body facing away from the vehicle body,
wherein the rubber element is compressed when the auxiliary frame and the vehicle body are connected with a resilient releasable connection.
